(19) United States
(12) Patent Application Publication
(10) Pub. No.: US 2006/0046736 A1
(43) Pub. Date: Mar. 2, 2006

(54) Methods and apparatus for managing wireless device power consumption by selecting among plural communication transceivers

(76) Inventors: Trevor A. Pering, Mountain View, CA (US); Muralidharan Sundararajan, Portland, OR (US); John J. Light, Beaverton, OR (US); Roy Want, Los Altos, CA (US); Vijay Raghunathan, Los Angeles, CA (US)

Correspondence Address: BUCKLEY, MASCHOFF, TALWALKAR LLC, 5 ELM STREET, NEW CANAAN, CT, 06840, US

(21) Appl. No.: 10/930,303

(22) Filed: Aug. 31, 2004

(51) Int. Cl. H04B 1/38

(52) U.S. Cl. 455/452.2; 455/552.1

(57) ABSTRACT

A portable electronic device includes a first type of wireless transceiver and a second type of wireless transceiver. The device determines at least one of the quantity and type of data currently required to be transmitted. One of the two transceivers is selected based on the determined type and/or quantity of data required to be transmitted. The data is then transmitted using the selected one of the wireless transceivers. Other embodiments are described and claimed.

### BACKGROUND

For portable electronic devices such as PDAs (personal digital assistants), cellular telephones and laptop computers, battery life is often a critical factor in useability and user satisfaction. Frequently, it is necessary to make difficult trade-offs to preserve an adequate battery life in a portable electronic device. For example, it is typically a desired feature of such devices to provide wireless data communication to and from such devices at as high a bandwidth as possible. However, higher bandwidth communication interfaces typically draw more power than lower bandwidth communication interfaces. Accordingly bandwidth, and thus convenience of communication, is often traded off against battery life in portable electronic devices.

### BRIEF DESCRIPTION OF THE DRAWINGS

FIG. 1 is block diagram of a system according to some embodiments which provides for data communication with a mobile communication device.

FIG. 2 is a block diagram of a mobile communication device that is part of the system of FIG. 1.

FIG. 3 is a block diagram of a typical one of the access points that are part of the system of FIG. 1.

FIG. 4 is a schematic representation of a sequence of signals exchanged according to some embodiments between an access point and a mobile communication device in the system of FIG. 1.

FIG. 5 is a flow chart that illustrates a process performed according to some embodiments in the access point of FIG. 3.

FIG. 6 is a flow chart that illustrates a process performed according to some embodiments in the mobile communication device of FIG. 2.

### DETAILED DESCRIPTION

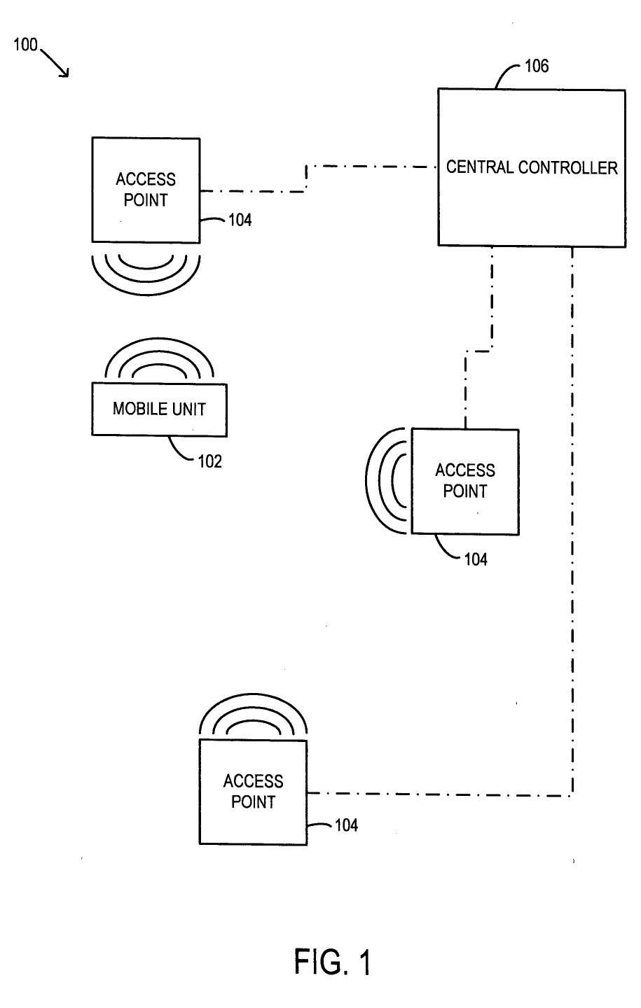

FIG. 1 is a block diagram of a system 100 according to some embodiments. The system 100 provides for wireless data communication with a mobile communication device 102. As used herein, “mobile communication device” refers to any portable electronic device that is capable of wireless data communication with another device (whether such other device is fixed or portable). Examples of mobile communication devices include wireless-enabled PDAs, cellular telephones, and wireless-enabled laptop or notebook computers. (Although only one mobile communication device is shown in FIG. 1, it should be understood that the system 100 may advantageously be capable of supporting wireless communication with a large number of mobile communication devices.)

As seen from FIG. 1, the system 100 includes a plurality of “access points” 104. (Although only three access points 104 are shown in the drawing, it should be understood that in practice the system 100 may include a large number of access points distributed over a wide geographical area.) The term “access point”, as used herein, refers to a stationary hardware device, sometimes also referred to as a base station, which is capable of providing a wireless communication connection to a mobile communication device.

In addition, the system 100 includes a central controller 106 that is in communication with the access points 104 and may manage data communications sent to or from the mobile communication device 102 via one or more of the access points 104. The central controller 106 may, for example, be in communication with other devices, such as server computers, personal computers, other mobile communication devices (all not shown) via other communication links such as a data communication network (not shown; e.g., the Internet).

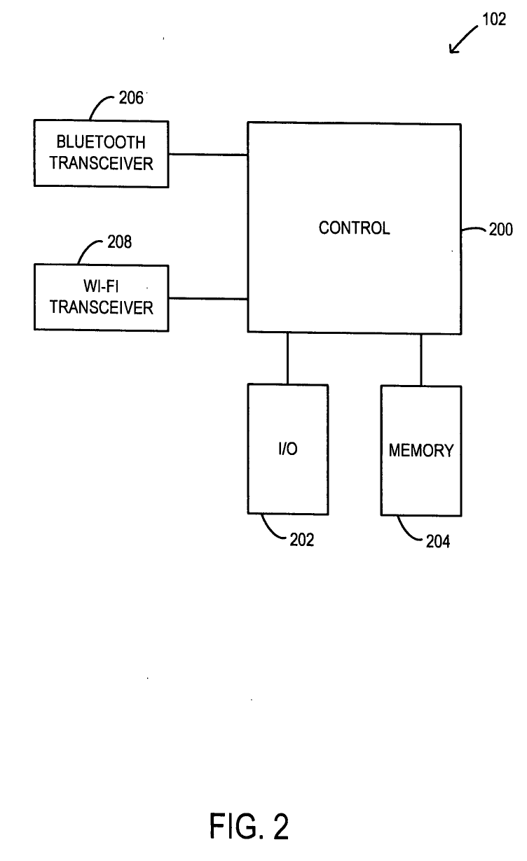

FIG. 2 is a block diagram of the mobile communication device 102 as provided according to some embodiments. The mobile communication device 102 includes a control circuit 200, which may, for example, be a conventional microprocessor, microcontroller, ASIC (application specific integrated circuit) or other device included in a PDA or cellular telephone or the like to control the mobile communication device.

The mobile communication device 102 also includes one or more input/output (I/O) devices coupled to the control circuit 200. The I/O devices are represented by block 202 in FIG. 2 and may include, for example, a display screen (e.g., a touch screen) and/or a keypad. The mobile communication device 102 may also include one or more memory devices 204 which are coupled to the control circuit 200 and which may serve, for example, as program memory, working memory, etc.

Further, in accordance with some embodiments, the mobile communication device 102 may include a plurality of wireless data communication transceivers, such as a Bluetooth transceiver 206 and a Wi-Fi transceiver 208, which are coupled to and controlled by the control circuit 200. Each of the transceivers 206, 208 may include a suitable antenna (not separately shown) which may be shared with the other transceiver.

The mobile communication device 102 may include other components, which are not shown, such as a housing which is shaped and sized to fit in a user's palm and which contains and/or supports all the other components of the mobile communication device 102. In some embodiments, the mobile communication device 102 may be a PDA, a cellular telephone, or a laptop computer, for example.

As is familiar to those who are skilled in the art, the Bluetooth transceiver 206 is a relatively low-cost, low-power, low-bandwidth device as compared to the Wi-Fi transceiver 208. The Wi-Fi transceiver 208, on the other hand, may provide roughly an order of magnitude higher bandwidth than the Bluetooth transceiver 206, while drawing perhaps an order of magnitude more power than the Bluetooth transceiver 206.

In accordance with some embodiments, the Wi-Fi transceiver 208 may normally be turned off, but may be turned on automatically by the control circuit 200 when there is a need for high bandwidth data communication by the mobile communication device 102. Because the Wi-Fi transceiver 208 may be more power-efficient than the Bluetooth transceiver 206 when a relative large quantity of data is to be transmitted or received, this arrangement may provide the mobile communication device 102 with “the best of both worlds”—relatively low power consumption by usually powering down the Wi-Fi transceiver and using the low power Bluetooth transceiver in standby mode to keep the mobile communication device in touch with the system 100, while using the Wi-Fi transceiver when high-bandwidth communication is needed.

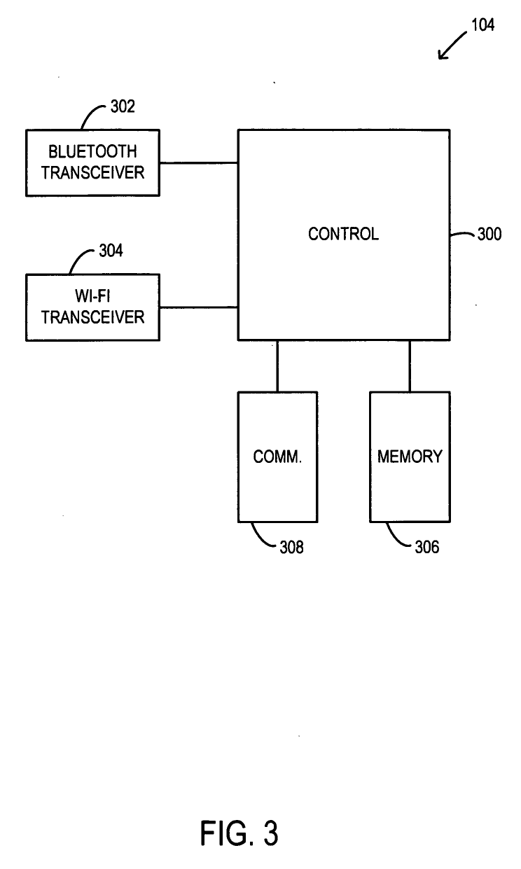

FIG. 3 is a block diagram of a typical one of the access points 104. The access point 104 includes a control circuit 300. The control circuit 300 may be a microprocessor, microcontroller, ASIC or other device typically employed to control an access point.

The access point 104 may also include plural wireless data communication transceivers compatible with the data communication protocols utilized by the mobile communication devices to be supported by the system 100. For example, the access point 104 may include a Bluetooth transceiver 302 and a Wi-Fi transceiver 304, both coupled to and controlled by the control circuit 300.

In addition, the access point 104 may include one or more memory devices 306 coupled to the control circuit 300 to serve as program and/or working memory or the like, and may include one or more communication devices 308 to, e.g., allow the access point 104 to exchange data communication with the central controller 106. Unlike the mobile communication device 102, the access point may lack a user interface.

Since the Bluetooth transceiver of the mobile communication devices may have a relatively short range, the system 100 may include additional access points having only Bluetooth transceivers as well as main access points that have both Bluetooth and Wi-Fi transceivers.

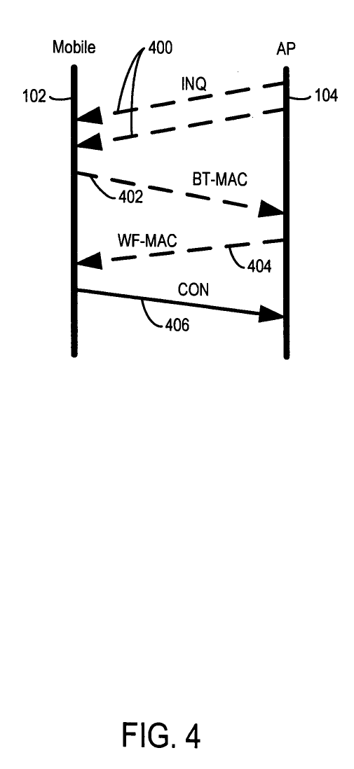

FIG. 4 schematically illustrates an exchange of handshaking signals performed in accordance with some embodiments between an access point (AP) 104 and a mobile communication device 102. It will be appreciated that the respective control circuits of the access point 104 and the mobile communication device 102 may be programmed to perform the procedure illustrated in FIG. 4.

As indicated at 400, the access point 104 broadcasts at regular intervals the inquiry (“INQ”) signal called for by the Bluetooth communication protocol to allow the access point 104 to be made aware of any nearby mobile communication devices that support Bluetooth communications. The INQ signals 400 may contain Bluetooth addressing information for the access point in question. In other embodiments, the INQ signals merely indicate the presence of the access point and do not contain addressing information.

One of the INQ signals 400 may be received by the Bluetooth transceiver 206 of a nearby mobile communication device 102. The mobile communication device 102 responds to the INQ signal 400 with a Bluetooth signal 402. The signal 402 may include the Bluetooth address information (BT-MAC address—where “MAC” stands for Media Access Control) for the mobile communication device 102.

The Bluetooth transceiver 302 of the access point receives the signal 402. In response, the Bluetooth transceiver 302 of the access point sends a Bluetooth signal 404, addressed to the Bluetooth address of the mobile communication device. The signal 404 includes Wi-Fi address information (e.g., WF-ESSID—Wi-Fi extended service set identification—or other address information) by which the access point may be addressed in accordance with the Wi-Fi wireless data communication protocol.

The Bluetooth transceiver 206 of the mobile communication device receives the signal 404. The mobile communication device is now able to establish a wireless data communication connection (“CON”, as indicated at 406) with the access point in accordance with either one of the Bluetooth and Wi-Fi protocols, depending on the current needs of the mobile communication device.

In some embodiments, if the access point includes only a Bluetooth transceiver and not a Wi-Fi transceiver, the WF-MAC provided to the mobile communication device at 404 may be that of another nearby access point that includes a Wi-Fi transceiver, and the mobile communication device may connect to that other access point if Wi-Fi communication is currently the appropriate protocol for the mobile communication device to use.

In some embodiments, the handshaking procedure of FIG. 4 may be varied in a number of respects. For example, the INQ signals may be sent by the mobile communication device, and upon receiving an INQ signal from the mobile communication device, the access point may respond by addressing to the mobile communication device a signal which includes both the BT-MAC and the WF-MAC for the access point. In this case as well, the mobile communication device may then select whichever one of the Bluetooth and Wi-Fi protocols is currently most appropriate for its needs for the purpose of establishing a wireless data communication connection with the access point.

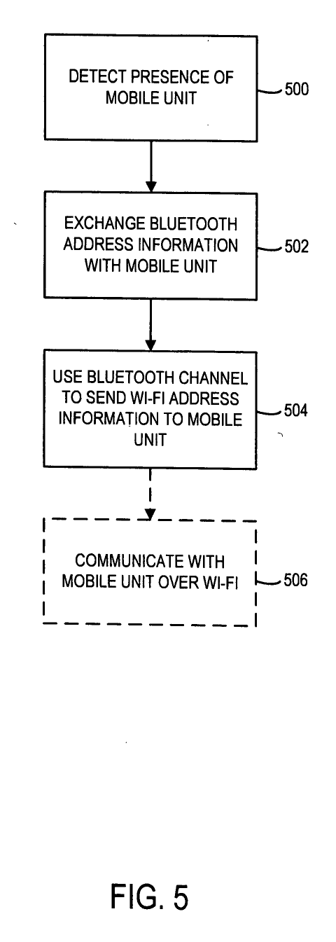

FIG. 5 is a flow chart that illustrates a process that may be performed in an access point 104 of the system 100 in accordance with some embodiments. It will be appreciated that the control circuit 300 of the access point 104 may be programmed (by, e.g., software stored in the memory 306) to perform the process of FIG. 5.

At 500 in FIG. 5, the access point operates to detect the presence of a mobile communication device. At 502 the access point exchanges with the mobile communication device, via the respective Bluetooth transceivers of the access point and the mobile communication device, Bluetooth address information (e.g., BT-MAC information for the mobile communication device and for the access point). With the Bluetooth address information, wireless data communication is enabled between the mobile communication device and the access point via the Bluetooth wireless data communication protocol.

Then, as indicated at 504 in FIG. 5, the access point uses the Bluetooth protocol to send to the mobile communication device, via the respective Bluetooth transceivers of the access point and the mobile communication device, the Wi-Fi address information (e.g., WF-MAC) for the access point, to enable wireless data communication between the mobile communication device and the access point via the Wi-Fi wireless data communication protocol. Then, as indicated at 506, communication in accordance with the Wi-Fi technique may occur, in some cases, between the access point and the mobile communication device.

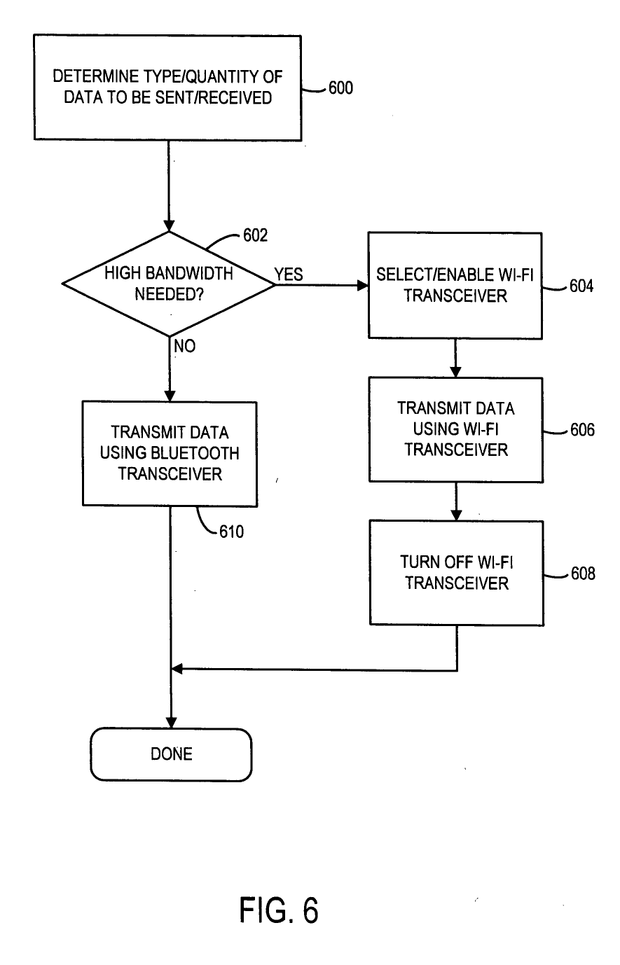

FIG. 6 is a flow chart that illustrates a process that may be performed in the mobile communication device 102 in accordance with some embodiments. It will be appreciated that the control circuit 200 of the mobile communication device 102 may be programmed (by, e.g., software stored in the memory 204) to perform the process of FIG. 6.

The process of FIG. 6 may commence upon a determination by the mobile communication device that there is data to be transmitted from and/or to the mobile communication device. The mobile communication device may then determine, as indicated at 600 in FIG. 6, the quantity and/or the type of data currently required to be transmitted. A decision is made, as indicated at 602, as to whether, in view of the type and/or quantity of data to be transmitted, it would be advisable to use a high-bandwidth wireless data communication protocol to transmit the data. For example, if the quantity of data to be transmitted exceeds a certain threshold amount of data, then it may be decided that a high-bandwidth protocol is to be used. Alternatively, if the type of data is one, such as image data, which calls for high-bandwidth communication to ensure that the data is transmitted within an acceptable length of time, again it may be decided that a high-bandwidth protocol is to be used.

If a positive determination is made at 602 (i.e., if it is determined that high-bandwidth data communication is in order) then the mobile communication device, via its control circuit 200, may automatically select the Wi-Fi transceiver 208 for operation, as indicated at 604. In some embodiments (e.g., when the mobile communication device is operating with a very limited supply of power), the Wi-Fi transceiver 208 may normally be maintained in a powered-off condition to conserve battery power, and “selecting” the Wi-Fi transceiver 208 may include powering-on the Wi-Fi transceiver. The Wi-Fi transceiver may then be used to transmit the data, as indicated at 606. After transmission of the data is complete, the Wi-Fi transceiver 208 may then be powered-off, as indicated at 608. The process of FIG. 6 is then complete.

In some embodiments the decision at 602 as to whether to employ high-bandwidth data communication may depend at least in part on the availability of power supply for the mobile communication device. For example, if the mobile communication device is plugged into a wall power outlet (e.g., via an AC to DC power converter, which is not shown) or to an automobile power outlet, and/or if the battery (not shown) of the mobile communication device is relatively fully charged, it may be determined that high-bandwidth data communication is in order, regardless of the nature or quantity of data to be transmitted.

Alternatively, if at 602 a negative determination is made (i.e., if high-bandwidth data communication is not in order), then the mobile device may automatically select, via its control circuit 200, the Bluetooth transceiver 206 for the current data communication needs. In some embodiments the Bluetooth transceiver 206 is normally maintained in a powered-on condition, albeit perhaps in a low power stand-by mode of operation. Selecting the Bluetooth transceiver 206 may include switching the Bluetooth transceiver from a stand-by mode to an active mode of operation. The Bluetooth transceiver may then be used, as indicated at 610, to transmit the data which currently requires transmission. When transmission of the data is complete, the Bluetooth transceiver may then be switched back to a stand-by mode in which address information (including both Bluetooth and Wi-Fi address information) may be exchanged with whatever access point or access points the mobile communication device may be near from time to time.

The above described embodiments have been illustrated in connection with examples in which the mobile communication device is equipped with a Bluetooth transceiver and with a Wi-Fi transceiver. However, in other embodiments, the mobile communication device may be equipped with any two or more types of wireless data communication transceivers and/or transmitters, and access points may be provided to support the types of communication of which the mobile communication device is capable. It may be the case that trade-offs between the two or more transceivers may involve any one or more of such factors as bandwidth, power consumption, range, latency, security and jitter.

In embodiments described above, the mobile communication device communicates with fixed access points. However, in other embodiments, the mobile communication device may communicate with other devices (e.g., in a peer-to-peer communication mode), such as other mobile communication devices and/or desk-top computers with wireless communication capabilities, in addition to or instead of the mobile communication device communicating with fixed access points. Accordingly, the definition of “access point” should be understood to encompass any device with which a mobile communication device communicates by a wireless communication path.

Differences in bandwidth have been discussed herein as a motivation to select between two different transceivers. However, in some embodiments a selection between two different transceivers may be made for other or additional reasons, such as differences in range and/or latency, security, jitter.

In some embodiments, the mobile communication device may permit the user to provide manual input to select between using the Bluetooth and Wi-Fi transceivers. This may be useful, for example, in a case where all of the local access points are Wi-Fi-only devices, in which case the user may manually place the mobile communication device in a mode to use its Wi-Fi transceiver.

The several embodiments described herein are solely for the purpose of illustration. The various features described herein need not all be used together, and any one or more of those features may be incorporated in a single embodiment. Therefore, persons skilled in the art will recognize from this description that other embodiments may be practiced with various modifications and alterations.

1. A method comprising:
providing a first type of wireless transceiver in a portable electronic device;
providing a second type of wireless transceiver in the portable electronic device, the second type of wireless transceiver different from the first type of wireless transceiver;
determining at least one of (i) a quantity of data currently required to be transmitted by the portable electronic device and (ii) a type of the data currently required to be transmitted by the portable electronic device;
automatically selecting one of the first and second types of wireless transceiver based at least in part on the determined type and/or quantity of data required to be transmitted; and
transmitting the data using the selected one of the wireless transceivers.

2. The method of claim 1, wherein the second type of wireless transceiver has a higher bandwidth than the first type of wireless transceiver.

3. The method of claim 2, wherein the first type of wireless transceiver consumes less power than the second type of wireless transceiver.

4. The method of claim 3, wherein the first type of wireless transceiver is a Bluetooth transceiver and the second type of wireless transceiver is a Wi-Fi transceiver.

5. The method of claim 1, further comprising:
receiving via the first type of wireless transceiver information for addressing an access point with the second type of wireless transceiver.

6. The method of claim 1, wherein the second type of wireless transceiver is disabled during the determining and is enabled in the event that it is selected in the automatic selecting.

7. The method of claim 1, wherein the portable electronic device is a personal digital assistant (PDA).

8. The method of claim 1, wherein the portable electronic device is a cellular telephone.

9. The method of claim 1, wherein the portable electronic device is a laptop computer.

10. The method of claim 1, wherein the selecting is based in part on a level of charge in a battery of the portable electronic device.

11. The method of claim 1, wherein the second type of wireless transceiver is powered-off when not selected.

12. An apparatus comprising:
a first wireless transceiver to perform data communication in accordance with a first data communication protocol;
a second wireless transceiver to perform data communication in accordance with a second data communication protocol that is different from the first data communication protocol; and
a control circuit coupled to the first and second wireless transceivers and operative to:
determine at least one of (i) a quantity of data currently required to be transmitted and (ii) a type of the data currently required to be transmitted;
automatically select one of the first and second wireless transceivers based at least in part on the determined type and/or quantity of data required to be transmitted; and
use the selected one of the first and second wireless transceivers to transmit the data.

13. The apparatus of claim 12, wherein the second wireless transceiver has a higher bandwidth than the first wireless transceiver.

14. The apparatus of claim 13, wherein the first wireless transceiver consumes less power than the second wireless transceiver.

15. The apparatus of claim 14, wherein the first wireless transceiver is a Bluetooth transceiver and the second wireless transceiver is a Wi-Fi transceiver.

16. The apparatus of claim 12, wherein the control circuit is further operative to receive via the first wireless transceiver information for addressing an access point with the second wireless transceiver.

17. The apparatus of claim 12, wherein the second wireless transceiver is disabled except when it is selected and used for transmitting data, and the first wireless transceiver is operated in a stand-by mode at times when it is not selected and used for transmitting data.

18. The apparatus of claim 12, wherein the apparatus is a personal digital assistant (PDA).

19. The apparatus of claim 12, wherein the apparatus is a cellular telephone.

20. The apparatus of claim 12, wherein the apparatus is a laptop computer.

21. The apparatus of claim 12, wherein the control circuit is operative to automatically select one of the first and second wireless transceivers based in part on a level of charge in a battery.

22. The apparatus of claim 12, wherein the second wireless transceiver is powered-off when not selected.

23. A method comprising:
receiving first address information from a mobile communication device, the first address information for enabling communication with the mobile communication device via a first wireless data communication protocol; and
using the first wireless data communication protocol to send second address information to the mobile communication device, the second address information for enabling communication with the mobile communication device via a second wireless data communication protocol that is different from the first wireless data communication protocol.

24. The method of claim 23, wherein the second wireless data communication protocol has a higher bandwidth than the first wireless data communication protocol.

25. The method of claim 24, wherein the first wireless data communication protocol is Bluetooth and the second wireless data communication protocol is Wi-Fi.

26. The method of claim 23, wherein the mobile communication device is a personal digital assistant (PDA).

27. The method of claim 23, wherein the mobile communication device is a cellular telephone.

28. The method of claim 23, wherein the mobile communication device is a laptop computer.

29. A method comprising:
providing a first type of wireless transceiver in a portable electronic device;
providing a second type of wireless transceiver in the portable electronic device, the second type of wireless transceiver different from the first type of wireless transceiver;
powering-off the second type of wireless transceiver while maintaining the first type of wireless transceiver in a stand-by mode of operation;
determining whether to power-on the second type of wireless transceiver based on at least one of (i) a quantity of data currently required to be transmitted by the portable electronic device and (ii) a type of the data currently required to be transmitted by the portable electronic device.

30. The method of claim 29, wherein the second type of wireless transceiver has a higher bandwidth than the first type of wireless transceiver.

31. The method of claim 30, wherein the first type of wireless transceiver is a Bluetooth transceiver and the second type of wireless transceiver is a Wi-Fi transceiver.

32. An apparatus comprising:
a storage medium having stored thereon instructions that when executed by a machine result in the following:
determining at least one of (i) a quantity of data currently required to be transmitted and (ii) a type of the data currently required to be transmitted;
automatically selecting one of first and second wireless transceivers based at least in part on the determined type and/or quantity of data required to be transmitted; and
using the selected one of the first and second wireless transceivers to transmit the data.

33. The apparatus of claim 32, wherein the second wireless transceiver has a higher bandwidth than the first wireless transceiver.

34. The apparatus of claim 33, wherein the first wireless transceiver consumes less power than the second wireless transceiver.

35. The apparatus of claim 34, wherein the first wireless transceiver is a Bluetooth transceiver and the second wireless transceiver is a Wi-Fi transceiver.

36. The apparatus of claim 32, wherein the instructions when executed by the machine further result in:
receiving via the first wireless transceiver information for addressing an access point with the second wireless transceiver.

37. An apparatus comprising:
a storage medium having stored thereon instructions that when executed by a machine result in the following:
receiving first address information from a mobile communication device, the first address information for enabling communication with the mobile communication device via a first wireless data communication protocol; and
using the first wireless data communication protocol to send second address information to the mobile communication device, the second address information for enabling communication with the mobile communication device via a second wireless data communication protocol that is different from the first wireless data communication protocol.

38. The apparatus of claim 37, wherein the second wireless data communication protocol has a higher bandwidth than the first wireless data communication protocol.

39. The apparatus of claim 38, wherein the first wireless data communication protocol is Bluetooth and the second wireless data communication protocol is Wi-Fi.

40. A system comprising:
an access point;
a portable electronic device in wireless communication with the access point, the portable electronic device including:
a Bluetooth transceiver;
a Wi-Fi transceiver;
a control circuit coupled to the Bluetooth and Wi-Fi transceivers and operative to:
determine at least one of (i) a quantity of data currently required to be transmitted and (ii) a type of the data currently required to be transmitted;
automatically select one of the Bluetooth and Wi-Fi transceivers based at least in part on the determined type and/or quantity of data required to be transmitted; and
use the selected one of the Bluetooth and Wi-Fi transceivers to transmit the data.

41. The system of claim 40, wherein the control circuit is further operative to receive via the Bluetooth transceiver information for addressing the access point with the Wi-Fi transceiver.

42. The system of claim 40, wherein the Wi-Fi transceiver is disabled except when it is selected and used for transmitting data, and the Bluetooth transceiver is operated in a stand-by mode at times when it is not selected and used for transmitting data.
